(19) United States
(12) Patent Application Publication
(10) Pub. No.: US 2011/0091659 A1
(43) Pub. Date: Apr. 21, 2011

(54) PROCESS FOR COLOURING ELEMENTS MADE OF POLYMERIC MATERIAL, IN PARTICULAR YARNS SELECTIVELY PRODUCED IN POLYETHYLENE (PE), IN ULTRA HIGH MOLECULAR WEIGHT POLYETHYLENE (UHMW-PE) AND DERIVATIVES THEREOF SUCH AS HSHM-PE

(76) Inventors: Marco Goretti, Abbadia Lariana (Lecco) (IT); Maria Antonietta Longhi, Abbadia Lariana (Lecco) (IT)

(21) Appl. No.: 12/737,208

(22) PCT Filed: Jun. 15, 2009
(86) PCT No.: PCT/IB2009/005929

§ 371 Date: Dec. 17, 2010

(30) Foreign Application Priority Data
Jun. 18, 2008 (IT) MI2008A001102

(51) Int. Cl. B05D 1/18; C09D 11/00; C09D 7/12

(52) U.S. Cl. 427/430.1; 106/287.24; 106/31.6; 106/31.8

(57) ABSTRACT

There is described a process for colouring elements made of polymeric material, in particular yarns produced selectively in polyethylene (PE), in ultra high molecular weight polyethylene (UHMW-PE) and derivatives thereof, such as HSHM-PE, comprising a step of immersing the elements (10) in a liquid colourant (1) comprising at least: water (2); pigments (3) chosen from anthraquinone colorants, azo colorants and inks for the textile industry; and additives (4) comprising at least an equalizing agent (6) and a dispersing agent (7); the immersion step being performed at a temperature between 50° C. and 220° C.

The invention relates to a process for colouring elements or products made of polymeric material, in particular yarns produced in polyethylene (PE), and/or in Ultra High Molecular Weight PolyEthylene (UHMW-PE), preferably polyolefinic or olefinic based, and/or derivatives thereof, such as High Strength and High Modulus PolyEthylene (HSHM-PE).

The process is of the type described in the preamble of claim 1.

As it is known, the colouring of elements or products made of polymeric material is subject to various problems.

Manufacturers of these yarns maintain them prevalently in their natural colour, i.e. the natural colour of the raw material.

In some cases colouring substances are applied, but the duration of the colouring through time is limited and unsatisfactory, in particular when the product is subjected to intense use.

In substance, various colouring processes have be implemented by the industry; however these are unable to penetrate the fibres of the single filaments in depth and in fact only achieve surface effects, which are not resistant to sea water or wash resistant, even in cold water.

In particular, in industry epoxy or acid based paints or colorants, or solvents in general are applied with a hot air drying process, and by evaporation in the case the use of solvents or the like.

As stated, these technical solutions have shown poor results.

In fact, the colouring detaches rapidly from the threads as a result of chemical, mechanical or physical stresses, according to the particular type of use.

Specifically, lack of or insufficient colouring of these yarns after the extrusion step thereof is a deeply felt problem, for example in the nautical sector, for ropes and sails, in the industrial sector, in the manufacturing sector of fabrics for defense purposes, such as bulletproof vests, in the cut-proof product sector, in the sportswear sector, in the sportfishing sector, where duration of the colour and camouflage in the water are of fundamental importance.

Said yarns, when used in the sectors specified, are subjected to high chemical physical stresses, to the action of salt, and to frequent washing.

Purely by way of example, yarns for fishing have a colouring of short duration due to contact with sand and stones present in the environment of use and due to the presence of alkalis in fresh water, or of sodium in salt water.

Consequently, the technical problem of how to colour said products is posed also by the users, who receive them uncoloured or with colourations of limited duration.

In this situation, the technical aim of the present invention is to make possible a colouration of elements made of polymeric material which is able to solve said technical problem and to substantially overcome the aforesaid drawbacks.

Within said technical aim, an important object of the invention is to obtain a process for colouring elements made of polymeric material, in particular multifilament yarns made of PE, polyethylene, polyolefinic or olefinic based textile yarns, of UHMW-PE and of derivatives such as HSHM-PE, which allows effective penetration of the colorants into the individual filaments.

Another important object of the invention is to obtain a permanent colouring for said yarns which are subjected to high chemical, mechanical and physical stresses, in particular in the cut-proof products sector, in order to highlight through colours the levels of use and employment of the finished product, in the nautical sector to highlight through colours the various strengths, in the sportswear sector, in the manufacturing sector of fabrics for defense purposes, such as bulletproof vests, in the sportfishing or professional fishing sector, e.g. in sportfishing, deep sea fishing or trolling, with long lines, fishing nets, in order to adapt the colour of the yarns to the intensity of the colour of the fresh, sea or brackish water, etc.

The technical aim and the objects specified are achieved by a process for colouring elements made of polymeric material, as claimed in the appended claim 1.

Preferred embodiments are highlighted in the dependent claims.

The characteristics and advantages of the invention are clarified below in a detailed description of a preferred embodiment of the invention, with reference to the accompanying drawings, wherein:

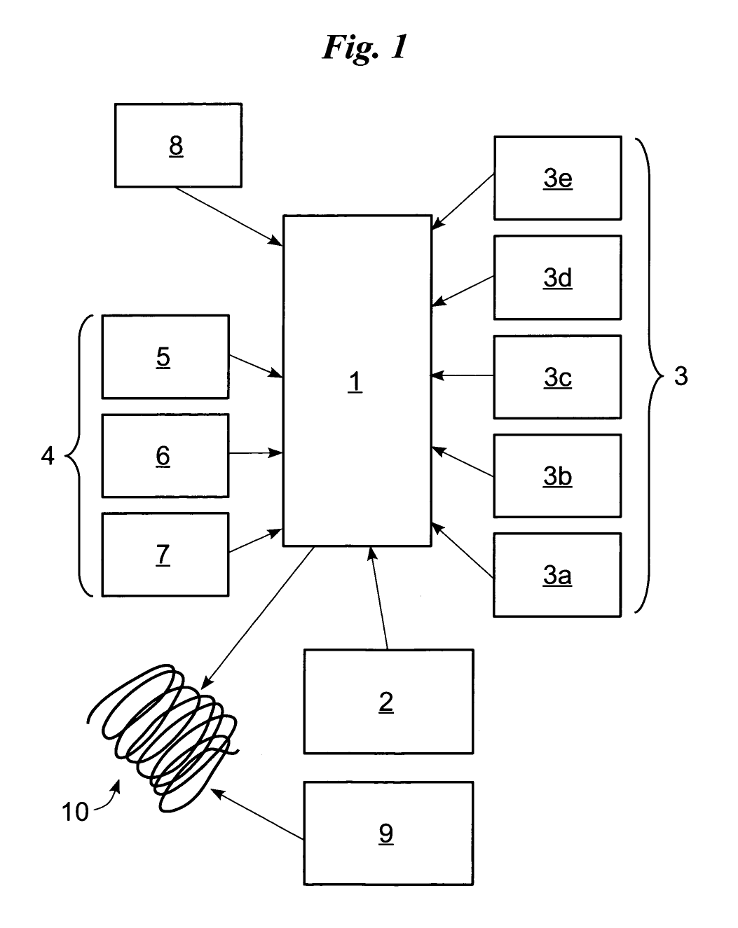

FIG. 1 schematically shows the colouring and composition steps of a colorant for polymeric materials according to the invention.

With reference to the FIGURE, the invention teaches a process for colouring an element or product 10 made of polymeric material, performed in particular after production thereof by extrusion, when this product still has the natural colour of the raw material.

The element or product 10 made of polymeric material is preferably a product realized by fibres forming a multifilament thread or yarn made of polyethylene (PE) or derivatives thereof, and more in particular of Ultra High Molecular Weight PolyEthylene (UHMW-PE), preferably polyolefinic or olefinic based, or derivatives thereof, such as High Strength and High Modulus PolyEthylene (HSHM-PE). The product 10 is preferably destined for the industrial sector; for the cut-proof products sector, to highlight the levels of use and employment of the finished product; for the sportswear sector, for example for motorcycle suits, for abrasion resistant fabrics; for the manufacturing sector of fabrics for defense purposes, such as bulletproof vests; for sportfishing or professional fishing.

In the fishing and nautical sector, once coloured the filament can be used, for example, to produce lines for loading reels for sportfishing or for deep sea fishing or trolling, for long lines, for fishing nets, for nautical ropes, sails, diving suits, for example to highlight through colours the various strengths or to make various products fluorescent in order to increase visibility thereof, above all in the evening when they are struck by a minimum source of light.

The process comprises a step of immersing a said element or product made of polymeric material 10 in a liquid colorant 1.

According to the process, the liquid colorant 1 is maintained, during the immersion step, at a temperature between 50° C. and 220° C. and more preferably, but not limitedly, between 62° C. and 102° C.

Moreover, the liquid colorant 1 is appropriately subjected to a pressure between 0.4 bars and 9.2 bars and more preferably between 0.4 bars and 4.8 bars. The immersion step can include one or more immersion cycles: from 1 to 20 and preferably from 1 to 4.

Each cycle can have a of between 1 minute and 500 minutes and preferably between 10 minutes and 90 minutes.

Summarily, the liquid colorant 1 is an aqueous solution and in fact comprises water 2, pigments 3, additives 4 and inks destined for the textile industry. The liquid colorant 1 is used in quantities in weight much greater than those of the product to be coloured: for example, the weight ratio between liquid colorant 1 and the product 10 to be coloured can be between 2:1 and 80:1, according to the shades to be obtained. It is preferably between 2:1 and 34:1.

Said pigments 3, included in the liquid colorant 1, are chemical colorants deriving from the anthraquinone family or from the azo family, or inks for the textile industry, chosen in variable percentages according to the colour and the shades of the thread to be coloured in depth.

Moreover, in the whole colouring process, only products that are not included in the list of forbidden azo colorants are used as colorants.

In detail, the pigments 3 are provided in quantities in weight between 0.2% and 15.0% and preferably between 0.9% and 8.0% of the weight of the product 10 to be coloured, according to the shades of colour required.

The pigments 3 are also realized by water dispersible particles 2. These particles can be of the type soluble or insoluble in water, but are preferably of the insoluble type.

Moreover, the pigments 3 comprise particles of various dimensions, for example large, medium and small—in relative sense—and each type of particles can be present in widely variable quantities in weight—between 0.002% and 99.97%—according to contingent needs, in particular according to the cross-section of the fibres of the product 10 to be coloured.

Said large, medium and small particles—in relative sense—have an average diameter, for example, of around 0.002 μm (the smallest) up to an average diameter of around 2 μm (the largest).

The average diameter of the particles can be detected by calculating the average Molecular Weight (MW). The average molecular weight MW is around 42 Atomic Mass Units (AMU) for the smallest particles, up to around 1360 AMU for the largest particles.

Preferably, said MW values are between 160 UMA and 980 UMA.

Purely by way of example, the pigments 3 are yellow (3a), blue (3b), black (3c), red (3d), green (3e) in colour and with these, in various combinations, a pleasant range of colours can be achieved.

In particular, products 10 coloured with yellow 3a and blue 3b pigments are suitable for the fishing and nautical sectors. Preferably, the yellow 3a and blue 3b pigments are provided in quantities respectively of between 0.06% and 2% and between 0.16% and 4% with respect to the quantity in weight of the element 10 made of polymeric material.

Products 10 coloured black are instead very suitable for motorcycle suits, bulletproof vests, etc.

The liquid colorant 1 also includes said additives 4 and these advantageously comprise a buffer agent 5, an equalizing agent 6 and a dispersing agent 7.

The buffer agent 5 is suitable to maintain the pH of the liquid colorant 1 stable at a value of between around 2.5 and 14, preferably between pH 3.2 and pH 9.5, for example, of 4.5.

For this purpose, the buffer agent 5 selectively includes acetic acid, formic acid, borax. It is present in quantities, related to the volume of water 2, between 5.0 g/l (grams per litre) and 0.02 g/l, preferably between 2.6 g/l and 0.2 g/l.

The equalizing agent 6 is suitable to equalize the percentage of success of the pigments 3: in practice, it makes the colouring homogeneous throughout the product 10, otherwise the colour would be uneven.

In detail, it is preferably an agent realized by one or more agents that can be based on polyglycol ether, and/or ethoxylated carboxylic acid and aryl sulphonate, and/or aromatic esters.

It is present in quantities, related to the volume of water 2, preferably between 4 g/l and 0.02 g/l.

The dispersing agent 7 is an anionic agent that disperses the pigments 3 in the water 2, pigments which otherwise would remain on the surface or would sink to the bottom.

It is also present in quantities, related to the volume of water 2, between 4 g/l and 0.02 g/l.

Moreover, to improve penetration of the colour, a carrier agent 8 can be employed, to be dispersed in the liquid colorant 1.

The purpose of the carrier agent 8 is to dilate the fibres of each single filament of the product 10 and to facilitate in depth penetration of the pigments in this filament, and it has a dosage between 0.30% and 13% of the weight of the product to be coloured, preferably between 1% and 7.8%.

To give even greater stability to the elements or products 10 made of polymer material destined for the sectors described, it is also possible to provide, after the immersion step, a finishing step in which the coloured products 10 are treated in specific plants to apply a filter agent 9 suitable to prevent fading thereof which can derive from UV rays or from frequent washing.

This filter agent 9 is preferably produced by a substance that filters UV rays.

The invention also teaches a new use of the liquid colorant 1 and in particular of pigments 3, chosen from anthraquinone colorants, azo colorants and inks destined for the textile industry, for colouring elements or products 10 made of PE, UHMW-PE, HSHM-PE, destined for the uses specified above.

It is also specified that the currently preferred use is that of the production of lines for sportfishing and professional fishing, where perfect camouflaging of the lines in water, either fresh or salt, is of the utmost importance.

The invention achieves important advantages.

In fact, it has been found that the described colouring process allows optimal colouring of elements made of polymeric material, and in particular of polyethylene or derivatives thereof.

In particular, experimental tests and inspections were carried out according to the method ISO 105-E02, in which a specimen is immersed in a solution of demineralised water including 30 g/l of sodium chloride, at a temperature of approximately 37° C. for around 4 hours. The specimens subjected to these tests did not suffer any fading, even partial.

The yarns were also subjected to UNI5258 and UNI8280 tests and did not suffer fading.

In particular, the colour penetrates in depth and is resistant to abrasion and surface cuts.

No colour loss occurred following washing at 60°.

Moreover, the colour is resistant to the chemical physical stresses of the alkaline environment typical of fresh and sea water.

Also as a result of the described combinations of yellow 3a and blue 3b pigments, the fishing lines coloured according to the described process also prove permanently camouflaged in water.

With regard to the yarns with pigments of other colour, in particular black pigments 3c, these also prove permanent after being subjected to the colour fastness test with a more aggressive method: they were immersed in water at a constant temperature of 80° C., for 20 minutes with the addition of a percentage of caustic soda, (NaOH), between 6% and 10%.

the result is excellent also in the case of successive washes: the danger of colour loss is excluded.

The invention is susceptible to modifications and variants falling within the inventive concept. The details can be replaced by equivalent elements.

1. A process for colouring elements (10) made of polymeric material, in particular yarns selectively produced in polyethylene, in ultra high molecular weight polyethylene, and derivatives thereof, said process comprising a step of immersing said elements (10) in a liquid colorant (1), and being characterized in that said liquid colorant (1) is formed by mixing at least: water (2); pigments (3) chosen from anthraquinone colorants, azo colorants, inks destined for the textile industry, additives (4) comprising at least an equalizing agent (6) and a dispersing agent (7); and in that said immersion step is performed at a temperature of said liquid colorant (1) between 50° C. and 220° C.; the weight ratio between said liquid colorant (1) and said elements (10) has a value between 2:1 and 34:1.

2. A process according to claim 1, wherein said immersion step is performed at a temperature of said liquid colorant (1) between 62° C. and 102° C.

3. A process according to claim 1, wherein said liquid colorant (1) in said immersion step is subjected to a pressure between 0.4 and 9.2 bars.

4. A process according to claim 1, wherein said liquid colorant (1) in said immersion step is subjected to a pressure between 0.4 and 4.8 bars.

5. (canceled)

6. A process according to claim 1, wherein in said immersion step said pigments (3) are present in quantities in weight between 0.2% and 15% with respect to the quantity in weight of said elements (10).

7. A process according to claim 1, wherein the pigments (3) are provided in yellow (3a) and blue (3b) colours and having in said immersion step quantities respectively between 0.2% and 2.0% and between 0.2% and 4.0%, with respect to the weight of said elements (10).

8. A process according to claim 1, wherein said equalizing agent (6) selectively includes substances based on polyglycol ether, on ethoxylated carboxylic acid and aryl sulphonate, on aromatic esters, and being provided in quantities between 4.0 and 0.02 grams for each litre of said water (2).

9. A process according to claim 1, wherein said dispersing agent (7) is defined by anionic agents present in quantities between 4.0 and 0.02 grams for each litre of said water (2).

10. A process according to claim 1, wherein said additives (4) comprise a buffer agent (5) selectively including acetic acid, formic acid, borax and present in quantities between 2.6 and 0.2 grams for each litre of said water (2).

11. A process according to claim 1, wherein said liquid colorant (1) also comprises a carrier agent (8), suitable to dilate said elements (10) made of polymeric material, said carrier agent (8) having in said immersion step a dosage between 1.0% and 7,8% of the weight of said elements (10) to be coloured.

12. A process according to claim 1, wherein said immersion step of elements (10) in said liquid colorant (1) comprises from one to four immersion cycles and wherein each of said immersion cycles has a duration between 10 and 90 minutes.

13. A process according to claim 1, wherein said immersion step is followed by a finishing step, in which said elements (10) are coated with a filter agent (9) suitable to protect said elements (10) from UV rays, said filter agent (9) being a substance that filters UV rays.

14. A liquid colorant for colouring elements (10) made of polymeric material, in particular yarns selectively produced in polyethylene (PE), in ultra high molecular weight polyethylene (UHMW-PE), in high strength and high modulus polyethylene (HSHM-PE), characterized in that it comprises:
a mixture of water (2), pigments (3), additives (4) comprising a buffer agent (5), an equalizing agent (6) and a dispersing agent (7);
said pigments (3) being chosen from anthraquinone colorants, azo colorants, inks for the textile industry, and being provided in quantities between 0.2% and 15% of the weight of said elements (10) to be coloured; said buffer agent (5) selectively including acetic acid, formic acid, borax and being provided in quantities between 2.6 and 0.2 grams for each litre of said water (2); said equalizing agent (6) selectively including substances based on polyglycol ether, on ethoxylated carboxylic acid and aryl sulphonate, on aromatic esters, and being provided in quantities between 4.0 and 0.02 grams for each litre of said water (2) and said dispersing agent (7) being defined by anionic agents present in quantities between 4.0 and 0.02 grams for each litre of said water (2).

15. Use of pigments (3) chosen from anthraquinone colorants, azo colorants and textile inks, for colouring elements (10) made of polymeric material, in particular yarns produced selectively in polyethylene (PE), in ultra high molecular weight polyethylene (UHMW-PE), in high strength and high modulus polyethylene (HSHM-PE).
